(19) United States
(12) Patent Application Publication
(10) Pub. No.: US 2009/0328077 A1
(43) Pub. Date: Dec. 31, 2009

(54) Software Appliances not Requiring Virtual Machines

(75) Inventor: Vivek Kashyap, Beaverton, OR (US)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/146,332

(22) Filed: Jun. 25, 2008

(51) Int. Cl. G06F 9/46

(52) U.S. Cl. 719/328

(57) ABSTRACT

Basing software appliances on a virtualization technique known as “Containers” enables the deployment of the software appliance on any host running a relevant containerized operating system. Basing virtual appliances on containers avoids incurring the additional overhead normally associated with virtual machines. For example, basing virtual appliances on containers avoids the installation, configuration and maintenance costs associated with running complex stacks of software, as well as the need for on-site support, while simultaneously avoiding the performance overhead and scaling limitations associated with running virtual machines.

### BACKGROUND OF THE INVENTION

1. Field of the Invention

This invention relates to the use of a software appliance based on a virtualization technique referred to as “Containers.”

2. Description of Background

Software appliances are an increasingly efficient and effective approach to deploying applications. Software appliances, however, require the inclusion of a streamlined operating system within the software appliance, which in turn requires the software appliance to run in a virtual machine. This approach has the performance overhead and scaling limitations associated with running virtual machines on a single host and does not allow the same software appliance to be useful in situations when the host is not a virtualized environment, in other words, not running a virtual machine monitor or hypervisor. Machines suitable for appliance include at least target systems that run the particular hypervisor for which the appliance is written.

### SUMMARY OF THE INVENTION

The present invention uses an operating system (“OS”) virtualization technique referred to as “Containers” to enable the software appliance to be deployed on any host running a relevant Containerized operating system without incurring the additional overhead normally associated with virtual machines.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

The present invention provides for capitalizing on the benefits associated with software appliances, for example the elimination of the installation, configuration and maintenance costs associated with running complex stacks of software, as well as the need for on-site support, while simultaneously avoiding the performance overhead and scaling limitations associated with running virtual machines on a single host.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:
FIG. 1 illustrates an environment for implementing a computer program product of the present invention.

FIG. 2 is a block diagram depicting a containerized operating system which may be utilized in by the present invention.

FIG. 3 is a block diagram depicting the utilization of the containerized operating system of FIG. 2 in the present invention.

The detailed description explains the preferred embodiments of the invention, together with advantages and features, by way of example with reference to the drawings.

### DETAILED DESCRIPTION OF THE INVENTION

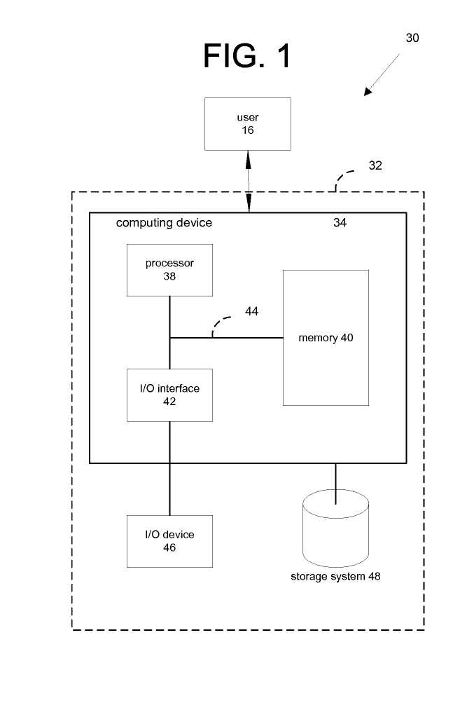

FIG. 1 shows an illustrative environment 30 for using a Container to enable a software appliance to be deployed on any host running a relevant Containerized operating system. To this extent, the environment 30 includes a computer infrastructure 32 that can perform the various processes described herein. In particular, the computer infrastructure 32 is shown including a computing device 34 operable to perform the steps. The computing device 34 is shown including a processor 38, a memory 40, an input/output (I/O) interface 42, and a bus 44. Further, the computing device 34 is shown in communication with an external I/O device/resource 46 and a storage system 48. As is known in the art, in general, the processor 38 executes computer program code, which is stored in memory 40 and/or storage system 48. While executing computer program code, the processor 38 can read and/or write data to/from memory 40, storage system 48, and/or I/O interface 42. The bus 44 provides a communications link between each of the components in the computing device 34. The I/O device 46 can comprise any device that enables an individual to interact with the computing device 34 or any device that enables the computing device 34 to communicate with one or more other computing devices using any type of communications link.

The computing device 34 can comprise any general purpose computing article of manufacture capable of executing computer program code installed thereon (e.g., a personal computer, server, handheld device, etc.). However, it is understood that the computing device 34 is only representative of various possible equivalent computing devices that may perform the processes described herein. Similarly, the computer infrastructure 32 is only illustrative of various types of computer infrastructures for implementing the invention. For example, in one embodiment, the computer infrastructure 32 comprises two or more computing devices (e.g., a server cluster) that communicate over any type of communications link, such as a network, a shared memory, or the like, to perform the process described herein.

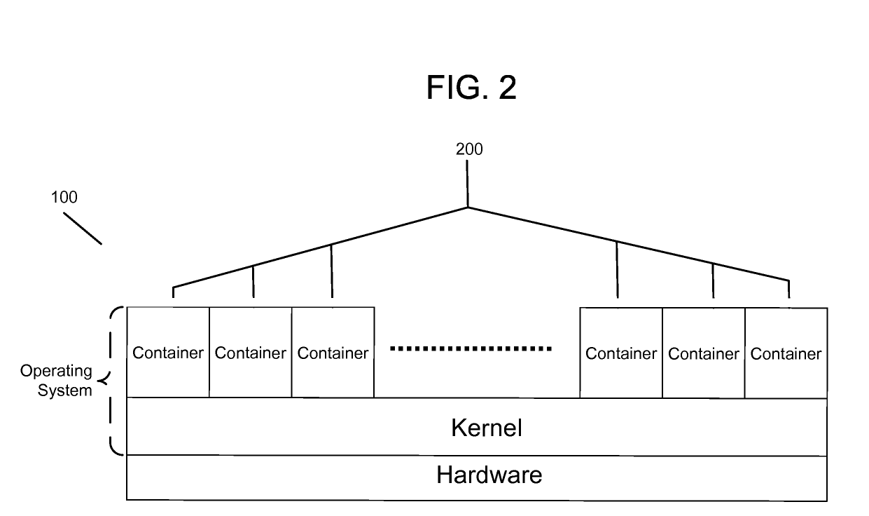

Referring to FIG. 2, the present invention comprises using a virtualization technique referred to as “Containers,” exemplified by “Linux Containers”, OpenVZ (swsoft.com), linux-vserver (linux-vserver.org), Solaris® zones/containers or IBM® AIX® workload partitions as a basis for deploying a software appliance. This approach enables the deployment of the software appliance on any host that employs a relevant Containerized operating system 100 without incurring the additional overhead normally required by a virtual machine. Containers 200 are generally included in all operating systems, such as, for example, Solaris® and AIX®. Most virtual machines, on the other hand, such as, for example, VMware® and Xen®, are optional add-ons that require the insertion of a thin layer of software between a computer's hardware and its operating system.

Software appliances running on a virtual machine require the inclusion of a streamlined operating system within the software appliance. This, in turn, requires the software appliance to run in a virtual machine. As a result, considerable effort is taken to include only necessary operating systems components in software appliances.

Because Containers 200 are generally included as standard components in operating systems 100, software appliances based on Containers 200 do not include any part of the operating system, thereby providing a truly streamlined appliance. Container-based software appliances also provide for the management of these software appliances as workloads once they are installed through management frameworks, such as, for example the IBM Director/Tivoli® suites, thereby leveraging common information model-based management of, for example, Linux/AIX® containers or, by extension, Solaris®/OpenVZ containers.

A software appliance requires the bundling of:
application;
libraries; and
other components (such as, for example, middleware and databases).

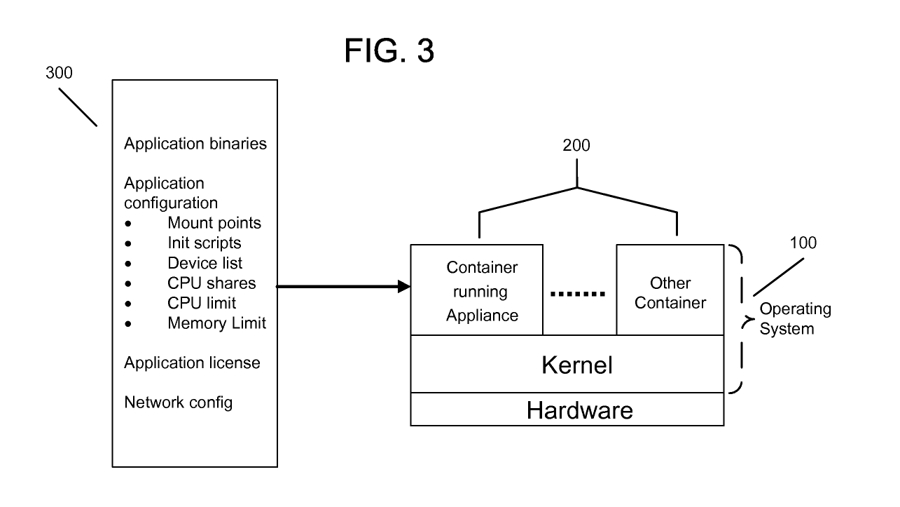

Referring to FIG. 3, the creation of the Container for the software appliance, which may be referred to as the launch of the software appliance, causes chroot and mount commands to carve out a filesystem domain for the Container. The binaries and or other files necessary for the operation of the software appliance are then downloaded and/or installed according to a predefined configuration. Since the host's filesystem can be shared by Containers, common libraries may be configured to be shared by virtual appliances running in Containers. If necessary, a configured network address and port are used to communicate to the installing server (such as, for example, the IBM Director update manager). Upon installation, the appliance runs as another workload in an independent container.

A Containers-based software appliance may include application binaries, scripts to initialize the Container, scripts to customize the application on first boot, and/or a description of the devices and resources required by the Containers. The container omits the operating system from the image. Deployment of the appliance may include reading an appliance file 300 and using a resource description and/or a Container description to create a new Container using the OS interfaces provided for Container management. At this stage, the tooling may copy a generic initialization script into a defined location, such as, by way of example, “/etc” on Linux systems. A Container environment simulates a virtual machine running an operating system and may therefore run an initialization program (pid 1 on Unix systems). This specialized Container initialization program will run the copied initialization script.

The Container appliance tooling on the target system will further create a set of mount points for the Container, for example, “/etc”, “/sys”, “/tmp”, “/var” and “/opt”, by carving out the shared file system. The “/etc” directory may be populated with init scripts as discussed above. The tooling may also ensure that the Container is able to share the devices and resources described in the appliance. An appliance may be encoded as a collection of specific sections in a file or a collection of files that the target's Container deployment tool can decipher. The tool may further copy the application image into the Container's view of the filesystem, such as, for example, into the “/opt” directory.

When the Container is thus initialized it has the necessary access to the filesystem. The initialization scripts may run to:
further configure the Container, for example, to query on license agreements or set passwords, and
further configure the application, for example, to set IP address/port number, the user id etc.

Similarly, the tooling may use the OS supplied interfaces to map necessary CPU and memory resources, such as CPU affinity, CPU shares associated with the appliance and memory limits associated with the appliance.

Since the appliance may be specific to the OS, the appliance may be deployed on any OS on any architecture using a single appliance specification. This contrasts advantageously with appliances built around hypervisors such as, for example, VMware® and Xen®, which are limited to the hardware architecture, for example the Intel® x86 and PowerPC architectures, and require the hypervisor to be present on the target,

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product comprising a computer useable medium including a computer readable program, wherein the computer readable program when executed on a computer causes the computer to:
read an appliance file;
create directories for mount points;
copy data from the appliance file, said data excluding an operating system, said data comprising:
application configuration information, said application configuration information comprising:
initialization scripts;
required resources; and
required devices; and
application binaries;
create a container description, said container description comprising a description of required mount points devices and resources;
create a container based on the description in the container description file; and
initialize the appliance.
